(19) United States
(12) Patent Application Publication
(10) Pub. No.: US 2005/0150983 A1
(43) Pub. Date: Jul. 14, 2005

(54) Flexible hose device for spraying purposes

(76) Inventor: Lung Yu Yang, Taichung (TW)

Correspondence Address: Lung Yu Yang, P.O. Box 63-99, Taichung, 406, TW

(21) Appl. No.: 10/755,187

(22) Filed: Jan. 8, 2004

(51) Int. Cl. B05B 3/00; B05B 3/18

(52) U.S. Cl. 239/736; 239/745; 239/740

(57) ABSTRACT

A flexible hose device includes a flexible tubular member, and a foldable cable received in the flexible tubular member and having an outer diameter smaller than an inner diameter of the flexible tubular member, to form a water passage between the flexible tubular member and the cable. The cable is foldable to various shapes to maintain the flexible tubular member in required shapes, and for spraying upper or other higher portions that may not be easily reached or cleaned by the users. The flexible tubular member includes a seat to secure the cable to the tubular member with the seat.

### BACKGROUND OF THE INVENTION

1. Field of the Invention

The present invention relates to a flexible hose device, and more particularly to a flexible hose device foldable to various shapes or contours for spraying upper portions or various portions that may not be easily reached or cleaned.

2. Description of the Prior Art

Various kinds of typical hose devices have been developed and provided for coupling various spraying devices to water reservoirs, and for water spraying purposes. The typical hose devices may comprise a telescopic structure having two or more tubes that may be retracted and adjusted relative to the other, for spraying water to different heights, and to clean upper portions that may not be easily reached or cleaned by the users.

For example, U.S. Pat. No. 2,257,585 to Auvil, U.S. Pat. No. 4,673,129 to Kologiy, U.S. Pat. No. 6,045,284 to Chiu, and U.S. Pat. No. 6,322,006 to Guo disclose four of the typical hose devices and each comprising a spraying device of a predetermined shape or contour, and/or a telescopic structure adjustable to each other to spray water to different heights.

However, the spraying devices comprise a predetermined shape or contour that may not be bent or folded to different shapes or contours, such that the spraying devices may not be used for spraying various portions that may not be easily reached or cleaned by the users, such as the engine chambers or the chassis of vehicles, or the like.

U.S. Pat. No. 4,739,801 to Kimura et al. discloses another typical hose device or flexible supporting sheaths or the like which comprises a number of links interconnected or coupled together with a number of sealing rings or gaskets, to form a snake tubular device.

In order to form a water tight seal in the snake tubular device, a number of sealing rings or gaskets are required to be sealingly engaged or coupled between the links, such that the typical flexible snake tubular device may not be easily manufactured or assembled.

In addition, when water is supplied and flows through the snake tubular device, the water may apply a water force against the snake tubular device, to straighten the snake tubular device, such that the snake tubular device also may not be used for spraying various portions that may not be easily reached or cleaned by the users.

The present invention has arisen to mitigate and/or obviate the afore-described disadvantages of the conventional flexible hose devices.

### SUMMARY OF THE INVENTION

The primary objective of the present invention is to provide a flexible hose device including a structure foldable to various shapes or contours for spraying upper portions or various portions that may not be easily reached or cleaned.

In accordance with one aspect of the invention, there is provided a flexible hose device comprising a flexible tubular member, and a foldable cable received in the flexible tubular member and including an outer diameter smaller than an inner diameter of the flexible tubular member, to form a water passage between the flexible tubular member and the cable. The cable is foldable to various shapes to maintain the flexible tubular member in required shapes, and for spraying the upper portions or various higher portions that may not be easily reached or cleaned by the users.

The flexible tubular member includes a seat secured thereto, the cable includes a first end secured the seat. The seat includes a mouth extended therefrom and engaged into the tubular member and secured to the tubular member.

The first end of the cable is an enlarged end and includes two opposite edges engaged into and secured to the seat. The first end of the cable is at least one cut off portion formed therein to permit water to flow through the cut off portion of the cable and to flow into the water passage defined between the flexible tubular member and the cable.

A hose may further be provided, and a securing ferrule may further be provided and attached onto the hose to secure the hose to the seat. The seat includes an outer peripheral shoulder formed therein, the securing ferrule includes an inner peripheral flange extended therefrom and engaged with the outer peripheral shoulder of the seat, to rotatably anchor the securing ferrule to the seat.

A pipe may further be provided and detachably secured to the hose. A retaining ring may further be provided and engaged onto the hose, and a control barrel may further be provided and threaded onto the pipe and engaged with the retaining ring, to force the retaining ring onto the hose.

The pipe includes an inclined inner peripheral surface formed therein, the retaining ring includes an inclined outer peripheral surface formed thereon and engaged with the inclined inner peripheral surface of the pipe. A conduit may further be provided and detachably secured to the pipe.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a flexible hose device in accordance with the present invention;

FIG. 2 is a partial exploded view of the flexible hose device;

FIG. 3 is another partial exploded view of the flexible hose device;

FIG. 4 is a partial cross sectional view taken along lines 4-4 of FIG. 5;

FIG. 5 is an end view of the flexible hose device as shown in FIG. 4;

FIGS. 6, 7, 8 are partial perspective views illustrating the operation of the flexible hose device;

FIG. 9 is a further partial exploded view of the flexible hose device;

FIG. 10 is a partial cross sectional view taken along lines 10-10 of FIG. 1; and

FIGS. 11, 12, 13, 14 are partial perspective views illustrating various spraying devices for attaching to the hose device.

### DETAILED DESCRIPTION OF THE PREFERRED EMBODIMENT

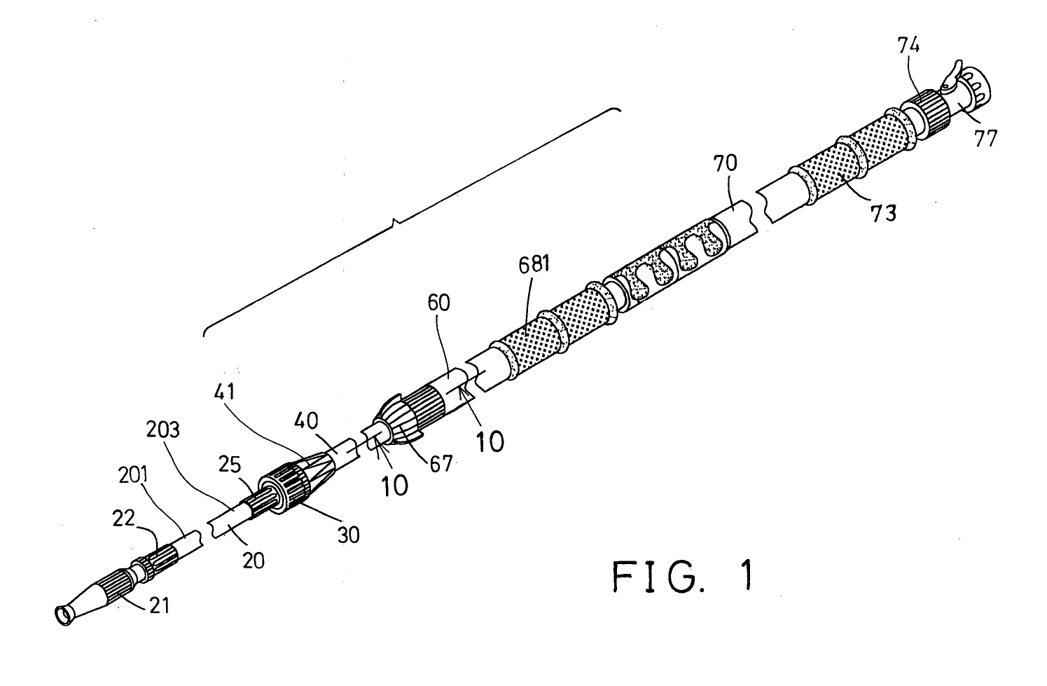

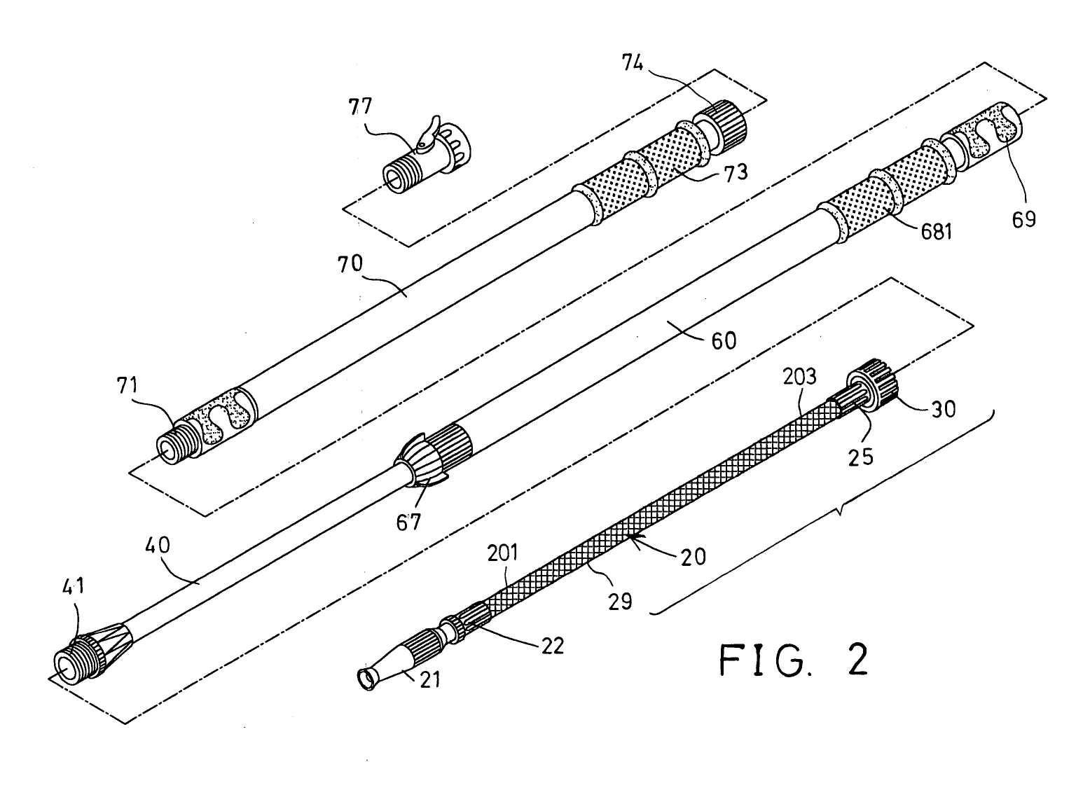

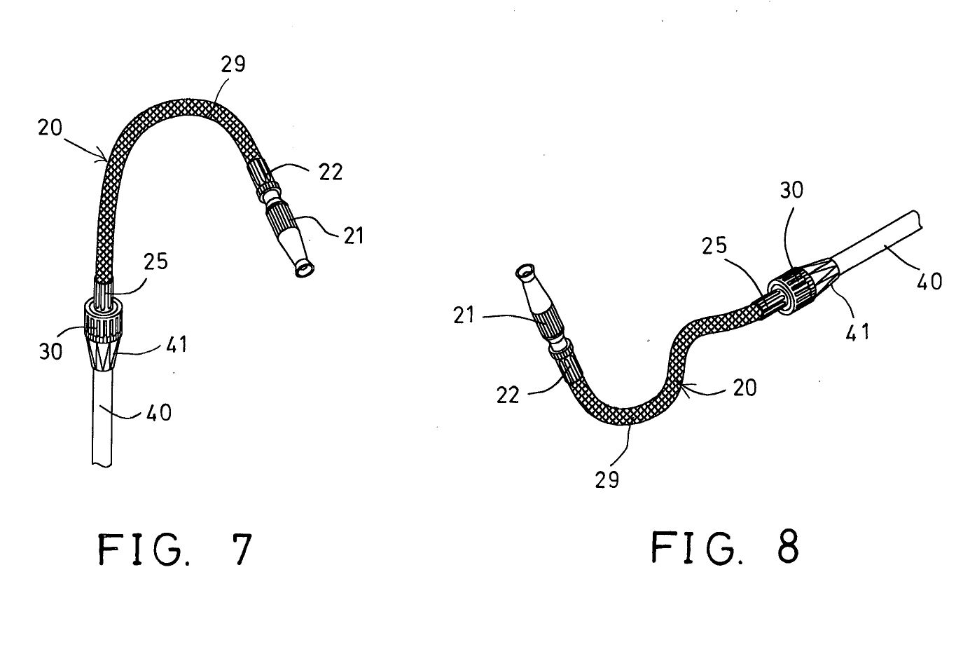

Referring to the drawings, and initially to FIGS. 1-5, a flexible hose device in accordance with the present invention comprises a flexible tubular member 20, a sprayer device 21 selectively secured to one end or front end 201 of the flexible tubular member 20 with such as a clamping ferrule 22, for water spraying purposes. The flexible tubular member 20 may further include a netting member 29 provided thereon (FIGS. 2-3 and 7-8) for reinforcing purposes.

A seat 23 includes a mouth 24 extended therefrom and engaged into the rear end 203 of the tubular member 20, and secured to the tubular member 20 with such as a clamping ferrule 25, and includes an outer peripheral rib 26 extended outwardly therefrom to form an outer peripheral shoulder 27 therein.

A securing ferrule 30 is rotatably engaged onto the seat 23, and includes an inner peripheral flange 31 extended therefrom and engaged with the outer peripheral rib 26 of the seat 23, to rotatably anchor and couple the securing ferrule 30 to the seat 23. The securing ferrule 30 includes an inner thread 33 formed therein. A sealing ring or gasket 34 may further be provided and disposed in the securing ferrule 30 and engaged or contacted with the seat 23.

A hose 40 includes a coupler 41 formed or provided on one end thereof for threading with the inner thread 33 of the securing ferrule 30 or for securing to the flexible tubular member 20 with the securing ferrule 30. The hose 40 may be coupled to a water reservoir for supplying the water out through the flexible tubular member 20 or the sprayer device 21.

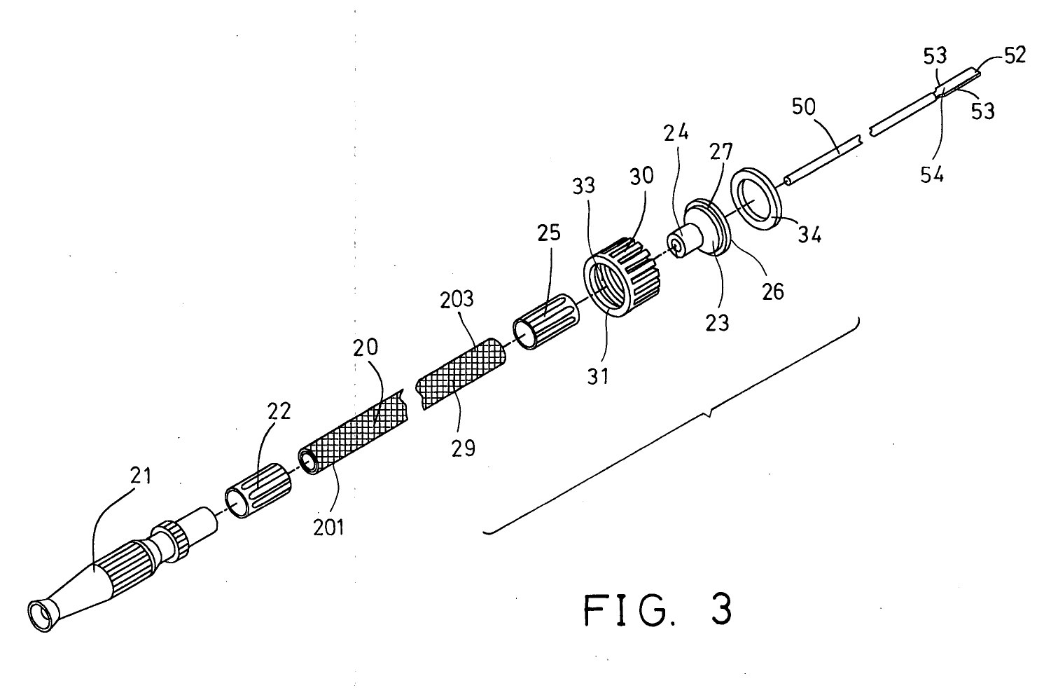

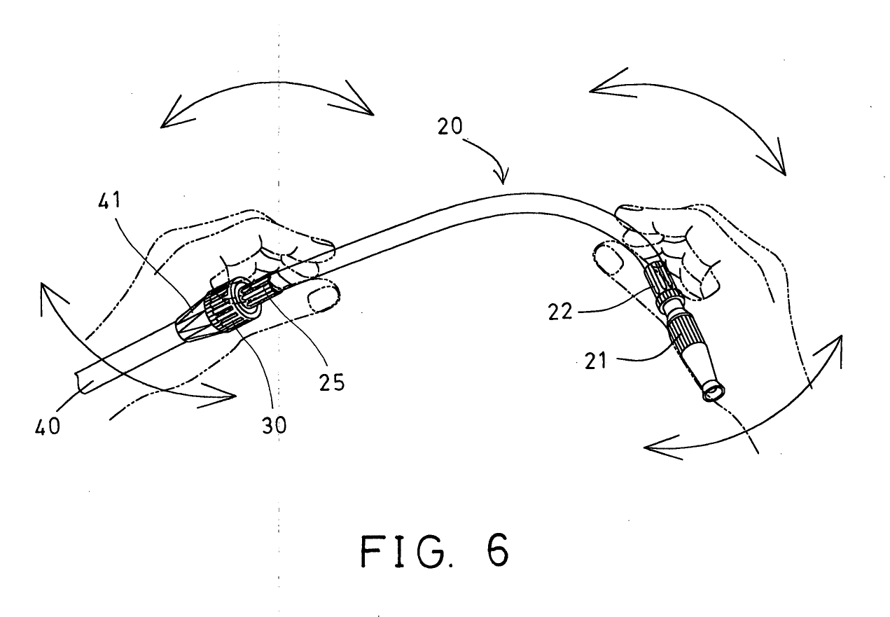

As best shown in FIGS. 3-5, a flexible or foldable cable 50 is engaged in the flexible tubular member 20 and includes an outer diameter smaller than the inner diameter of the flexible tubular member 20, to form an annular water passage 51 between the flexible tubular member 20 and the cable 50. The cable 50 may be made of metallic materials or the like, and may be bent or folded to various shapes, to retain the flexible tubular member 20 in the suitable or required shapes, as shown in FIGS. 6-8.

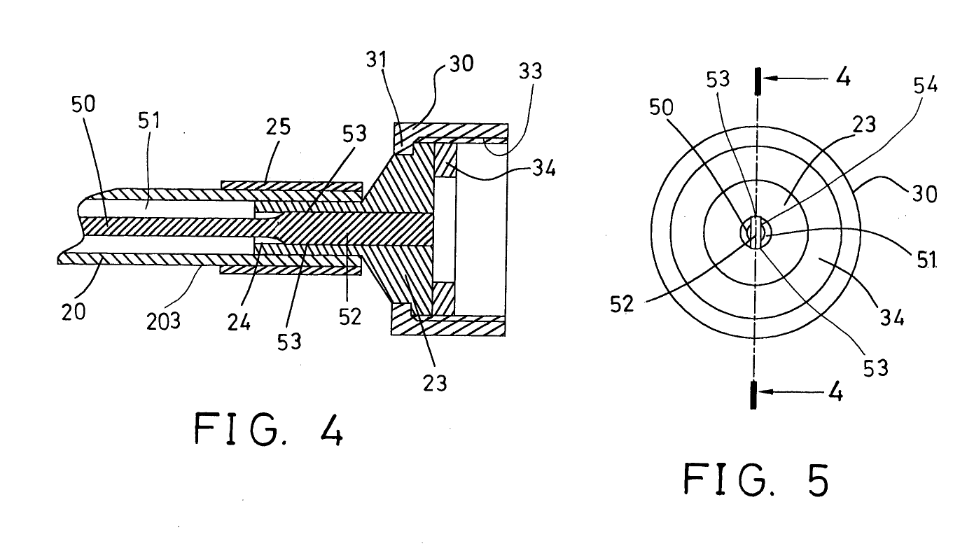

The cable 50 includes an enlarged end 52 secured to the seat 23. For example, the enlarged end 52 of the cable 50 includes two opposite edges 53 for being forced and engaged into seat 23 (FIGS. 4, 5), to secure the enlarged end 52 of the cable 50 to the seat 23, and thus to secure the cable 50 to the flexible tubular member 20 and within the flexible tubular member 20.

It is preferable that the enlarged end 52 of the cable 50 includes one or more flat surfaces or cut off portions 54 formed therein, for allowing or permitting water to flow beyond the enlarged end 52 of the cable 50, and then to flow out through the sprayer device 21 via the annular water passage 51 that is formed between the flexible tubular member 20 and the cable 50.

It is to be noted that the cable 50 may be easily engaged into any flexible tubular member 20 without providing and engaging one or more sealing rings or gaskets between the flexible tubular member 20 and the cable 50. In addition, the seat 23 may be easily engaged or coupled between the hose 40 and the flexible tubular member 20 with the clamping ferrule 25 and the securing ferrule 30.

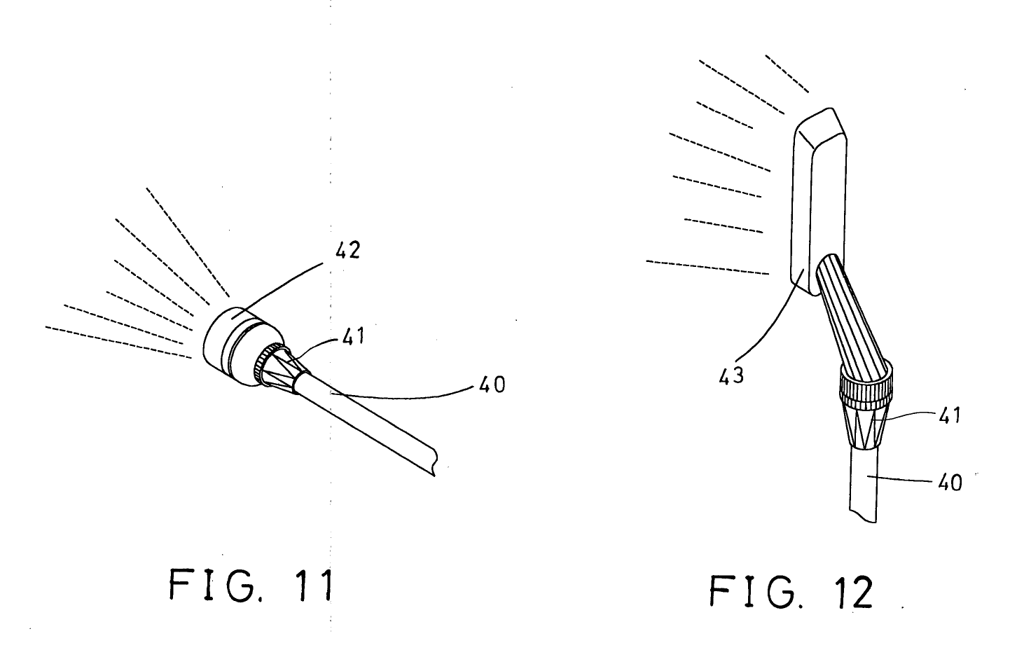

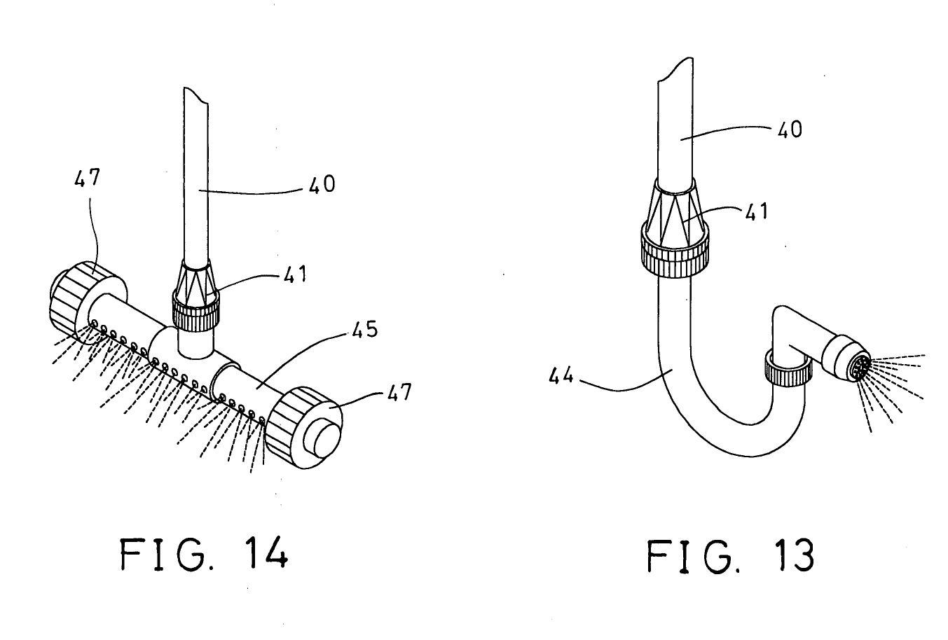

As shown in FIGS. 11-14, the other sprayer nozzles 42 (FIG. 11), or the other sprayer brushes 43 (FIG. 12), or the other sprayer guns 44 (FIG. 13), or the other sprinkling devices 45 (FIG. 14) may further be provided and coupled to the hose 40 with the coupler 41, or the like. The sprinkling device 45 (FIG. 14) may include one or more wheels 47 attached thereto for allowing the sprinkling device 45 to be easily moved relative to a supporting ground or surface.

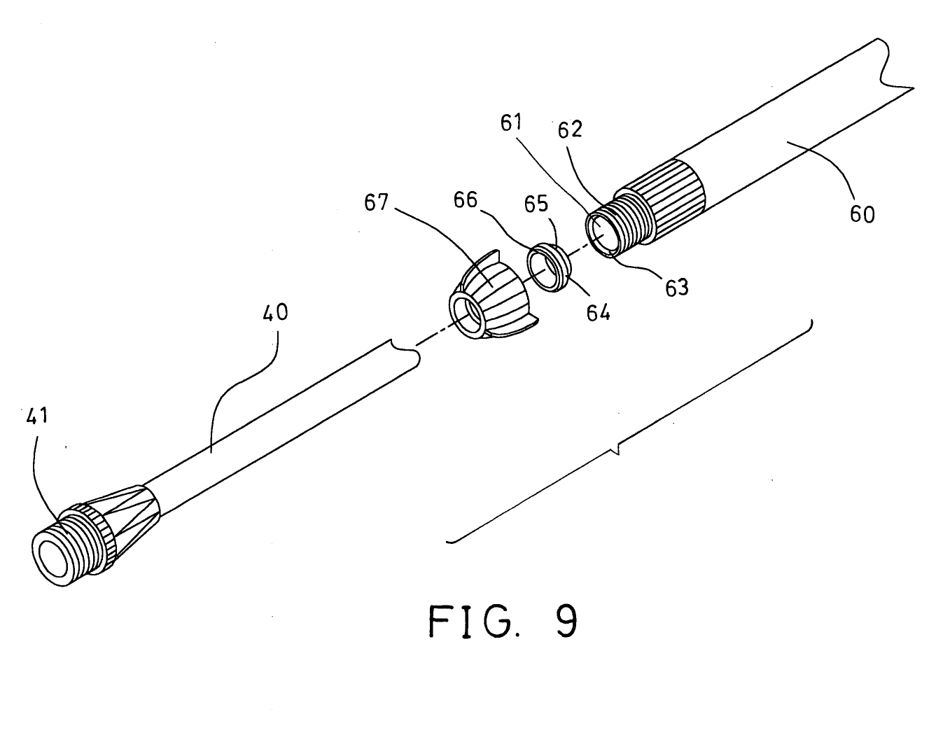

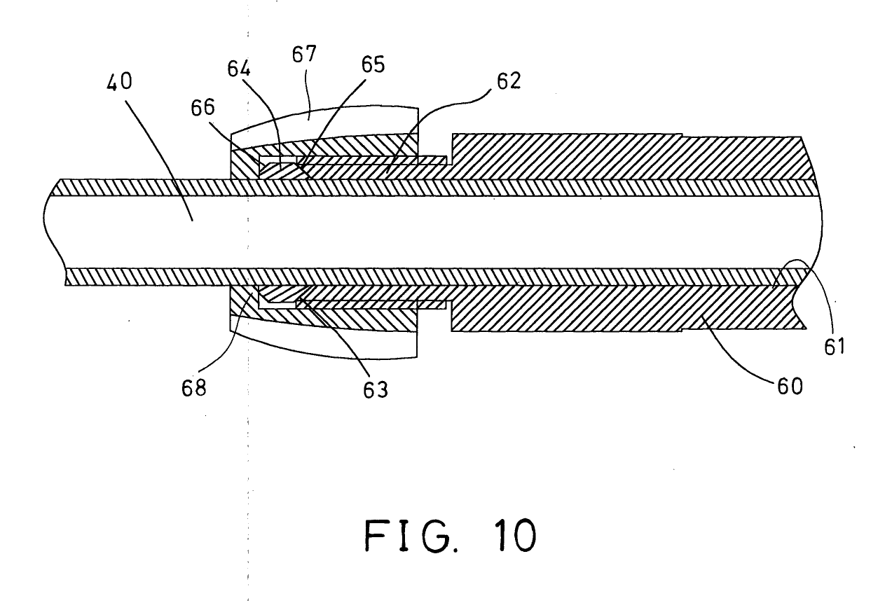

Referring next to FIGS. 9 and 10, and again to FIGS. 1 and 2, a pipe 60 may further be provided and includes a bore 61 formed therein to slidably or adjustably receive the hose 40, and includes an outer thread 62 formed on one end and an inclined inner peripheral surface 63 formed in the one end thereof.

A retaining ring 64 is engaged onto the hose 40 and includes an inclined outer peripheral surface 65 formed in one end thereof for engaging with the inclined inner peripheral surface 63 of the pipe 60 (FIG. 10), and preferable further includes an inclined outer peripheral surface 66 formed in the other end thereof.

A control barrel 67 is threaded onto the outer thread 62 of the pipe 60, and includes an inner peripheral flange 68 to engage with the retaining ring 64, and to force the retaining ring 64 onto or against the pipe 60, so as to force the retaining ring 64 to solidly engage onto the hose 40, and thus to solidly or detachably secure the hose 40 to the pipe 60. The pipe 60 may include a handle 681 provided on the other end 69 thereof for allowing the users to easily hold the pipe 60.

As shown in FIGS. 1 and 2, a further conduit 70 may further be provided and includes an outer thread 71 formed on one end thereof for securing to the other end 69 of the pipe 60, and includes a handle 73 provided on the other end thereof for allowing the users to easily hold the conduit 70. A coupler 77 may further be provided and coupled to the other end 74 of the conduit 70, for coupling the flexible tubular member 20 and/or the hose 40 and/or the pipe 60 and/or the conduit 70 to the water reservoirs.

The hose 40 and the pipe 60 and the conduit 70 may be selectively provided or coupled to the flexible tubular member 20, to allow the flexible tubular member 20 to be positioned to different heights, for supplying or spraying water to various heights for such as cleaning purposes.

It is to be noted that the provision or the engagement of the flexible or foldable cable 50 in the flexible tubular member 20 allows the flexible tubular member 20 to be bent or folded and maintained in various shapes or contours with the cable 50, without providing and engaging a number of sealing rings or gaskets between the flexible tubular member 20 and the cable 50.

Accordingly, the flexible hose device in accordance with the present invention includes a structure foldable to various shapes or contours for spraying upper portions or various portions that may not be easily reached or cleaned.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A flexible hose device comprising:
a flexible tubular member, and
a foldable cable received in said flexible tubular member and including an outer diameter smaller than an inner diameter of said flexible tubular member, to form a water passage between said flexible tubular member and said cable, and
said cable being foldable to various shapes to maintain said flexible tubular member in required shapes.

2. The flexible hose device as claimed in claim 1, wherein said flexible tubular member includes a seat secured thereto, said cable includes a first end secured said seat.

3. The flexible hose device as claimed in claim 2, wherein said seat includes a mouth extended therefrom and engaged into said tubular member and secured to said tubular member.

4. The flexible hose device as claimed in claim 2, wherein said first end of said cable is an enlarged end and includes two opposite edges engaged into and secured to said seat.

5. The flexible hose device as claimed in claim 2, wherein said first end of said cable is at least one cut off portion formed therein to permit water to flow through said at least one cut off portion of said cable and to flow into said water passage defined between said flexible tubular member and said cable.

6. The flexible hose device as claimed in claim 2 further comprising a hose, and a securing ferrule attached onto said hose to secure said hose to said seat.

7. The flexible hose device as claimed in claim 6, wherein said seat includes an outer peripheral shoulder formed therein, said securing ferrule includes an inner peripheral flange extended therefrom and engaged with said outer peripheral shoulder of said seat, to rotatably anchor said securing ferrule to said seat.

8. The flexible hose device as claimed in claim 6 further comprising a pipe detachably secured to said hose.

9. The flexible hose device as claimed in claim 8 further comprising a retaining ring engaged onto said hose, and a control barrel threaded onto said pipe and engaged with said retaining ring, to force said retaining ring onto said hose.

10. The flexible hose device as claimed in claim 9, wherein said pipe includes an inclined inner peripheral surface formed therein, said retaining ring includes an inclined outer peripheral surface formed thereon and engaged with said inclined inner peripheral surface of said pipe.

11. The flexible hose device as claimed in claim 8 further comprising a conduit detachably secured to said pipe.
